(19) United States
(12) Patent Application Publication
(10) Pub. No.: US 2015/0161519 A1
(43) Pub. Date: Jun. 11, 2015

(54) NAME RECOGNITION

(71) Applicant: Google Inc., (US)

(72) Inventors: Hongtao Zhong, Belmont, CA (US); Bryan Christopher Horling, Sunnyvale, CA (US)

(73) Assignee: Google Inc., Mountain View, CA (US)

(21) Appl. No.: 13/874,717

(22) Filed: May 1, 2013

Related U.S. Application Data
(60) Provisional application No. 61/813,854, filed on Apr. 19, 2013.

(51) Int. Cl. G06N 99/00

(52) U.S. Cl. CPC G06N 99/005

(57) ABSTRACT

A computer-implemented technique includes obtaining training electronic messages, identifying name context in the training electronic messages, and determining patterns from the name context. The technique can include applying the patterns to the training electronic messages to extract candidate names and selecting a set of the patterns based on the extracted candidate names to obtain a set of patterns. In some implementations, the technique can further include applying the set of patterns to electronic messages associated with a first user having a registered profile, extracting candidate names, and selecting a set of alternate names for the first user from the candidate names. The technique can also include detecting a use of one alternate name from the set of alternate names by a second user, and outputting a suggestion to the second user in response to the detecting, the suggestion being based on the registered profile of the first user.

### CROSS-REFERENCE TO RELATED APPLICATIONS

This application claims the benefit of U.S. Provisional Application No. 61/813,854, filed on Apr. 19, 2013. The entire disclosure of the above application is incorporated herein by reference.

### BACKGROUND

Users can communicate with each other via computing devices (desktop computers, laptop computers, tablet computers, mobile phones, etc.). The computing devices can be configured for communication via a computing network, e.g., the Internet, and/or other suitable communication mediums, e.g., Bluetooth. The users can transmit electronic messages back and forth to each other via their respective computing devices using a variety of different electronic messaging techniques (electronic mail, electronic chatting, text messaging, etc.). These electronic messaging techniques typically use specific addresses associated with user profiles, such as electronic mail addresses and telephone numbers, to route the communications. The user profiles, however, typically have a single registered name associated with a user. The sending user, therefore, may be required to manually input all the alternate names for each recipient user, which can be time consuming.

### SUMMARY

In one aspect, this disclosure features a computer-implemented method that includes obtaining, at a server including one or more processors, training electronic messages. The method can include identifying, at the server, one or more name contexts in the training electronic messages. The method can include determining, at the server, patterns from the name contexts, each pattern including a context around a name and an associated position for the name relative to the context. The method can include applying, at the server, the patterns to the training electronic messages to extract candidate names that correspond to the associated positions to obtain extracted candidate names. The method can include selecting, at the server, a set of the patterns based on the extracted candidate names. The method can also include storing, at the server, the set of patterns. Certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a server, such as by receiving consent from the user before obtaining electronic messages associated with the user.

In some embodiments, the training electronic messages are obtained from plurality of training users, and each specific training electronic message includes at least one known name associated with a specific field of the specific training electronic message.

In other embodiments, identifying the one or more name contexts in the training electronic messages includes identifying, at the server, N tokens surrounding each known name, wherein each token is a word or a punctuation, and wherein N is an integer greater than zero.

In some embodiments, determining the patterns includes determining, at the server, context for each combination of the N tokens surrounding the known name and determining the associated position at the known name to obtain the patterns.

In other embodiments, selecting the set of the patterns includes selecting each pattern that, when applied to the training electronic messages, extracts candidate names having greater than a first predetermined matching accuracy with actual names in the training electronic messages.

In some embodiments, the method further includes obtaining, at the server, electronic messages associated with a first user, the first user having a registered profile, applying, at the server, the set of patterns to the electronic messages to extract candidate names for the first user, selecting, at the server, a set of the candidate names having greater than a predetermined usage rate in the electronic messages to obtain a set of alternate names for the first user, and storing, at the server, the set of alternate names for the first user.

In other embodiments, the method further includes detecting, at the server, a use of one alternate name from the set of alternate names by a second user at a computing device, and outputting, from the server, a suggestion for the second user to the computing device, the suggestion being based on the registered profile for the first user.

In some embodiments, outputting the suggestion causes the computing device to automatically select a name for the first user that is associated with the registered profile for the first user.

In other embodiments, the use of the one alternate name by the second user is one of: (i) in a search query, wherein the suggestion is a result for the search query that is further based on the registered profile for the first user, (ii) in an address field of a draft electronic message or a body of the draft electronic message, wherein the suggestion is an address for the first user from the registered profile, and (iii) at a social network website, wherein the suggestion is a suggestion for the second user to add the first user to a group of users associated with the second user at the social network website.

In some embodiments, the method further includes applying, at the server, the set of patterns to the training electronic messages to extract candidate names for the training users, selecting, at the server, a set of the candidate names having less than than a second predetermined matching accuracy with actual names in the training electronic messages to obtain a set of ambiguous names, wherein the second predetermined matching accuracy is less than the first predetermined matching accuracy, and utilizing, at the server, the set of ambiguous names when selecting the set of alternate names for the first user by not selecting any names from the set of ambiguous names and when outputting the suggestion to the second user by not suggesting any names from the set of ambiguous names.

Also featured is a computer-implemented method that includes include obtaining, at a server including one or more processors, electronic messages associated with a first user, the first user having a registered profile. The method can include applying, at the server, a set of patterns to the electronic messages to extract candidate names for the first user, each pattern of the set of patterns including specific name context and an associated position for a name relative to the specific name context. The method can include selecting, at the server, a set of the candidate names to obtain a set of alternate names for the first user. The method can include storing, at the server, the set of alternate names for the first user. The method can include detecting, at the server, a use of one alternate name from the set of alternate names by a second user at a computing device. The method can also include outputting, from the server, a suggestion for the second user to the computing device, the suggestion being based on the registered profile for the first user.

In some embodiments, selecting the set of alternate names for the first user includes selecting candidate names having greater than a predetermined usage rate in the electronic messages to obtain the set of alternate names for the first user.

In other embodiments, the use of the one alternate name by the second user is one of: (i) in a search query, wherein the suggestion is a result for the search query that is further based on the registered profile for the first user, (ii) in an address field of a draft electronic message or a body of the draft electronic message, wherein the suggestion is an address for the first user from the registered profile, and (iii) at a social network website, wherein the suggestion is a suggestion for the second user to add the first user to a group of users associated with the second user at the social network website.

In some embodiments, the method further includes obtaining, at the server, training electronic messages, identifying, at the server, one or more name contexts in the training electronic messages, and determining, at the server, candidate patterns from the name contexts, each pattern including specific name context and an associated position for a name relative to the specific name context, each candidate pattern being a candidate for the set of patterns.

In other embodiments, the method further includes applying, at the server, the candidate patterns to the training electronic messages to extract candidate names that correspond to the associated positions, selecting, at the server, each candidate pattern that, when applied to the training electronic messages, extracts candidate names having greater than a first predetermined matching accuracy with actual names in the training electronic messages to obtain the set of patterns, and storing, at the server, the set of the patterns.

In some embodiments, the training electronic messages are obtained from plurality of training users, and wherein each specific training electronic message includes at least one known name associated with a specific field of the specific training electronic message.

In other embodiments, identifying the name context in the training electronic messages includes identifying, at the server, N tokens surrounding each known name, wherein each token is a word or a punctuation, and wherein N is an integer greater than zero.

In some embodiments, determining the patterns includes determining, at the server, name context for every combination of the N tokens surrounding the known name and determining the associated position at the known name to obtain the patterns.

In other embodiments, selecting the set of patterns includes selecting each candidate pattern that, when applied to the training electronic messages, extract candidate names having greater than a first predetermined matching accuracy with actual names in the training electronic messages;

In some embodiments, the method further includes applying, at the server, the set of patterns to the training electronic messages to extract candidate names for the training users, selecting, at the server, a set of the candidate names having less than a second predetermined matching accuracy with actual names in the training electronic messages to obtain a set of ambiguous names, wherein the second predetermined matching accuracy is less than the first predetermined matching accuracy, and utilizing, at the server, the set of ambiguous names when selecting the set of alternate names for the first user by not selecting any names from the set of ambiguous names and when outputting the suggestion to the second user by not suggesting any names from the set of ambiguous names.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 depicts a computing system including an example server according to some implementations of the present disclosure;

FIG. 2 depicts a functional block diagram of the example server of FIG. 1;

FIG. 3 depicts a flow diagram of an example method for automatically determining patterns of name context from electronic messages according to some implementations of the present disclosure; and

FIG. 4 depicts a flow diagram of an example method for automatically determining and using alternate names of users at computing devices according to some implementations of the present disclosure.

### DETAILED DESCRIPTION

Electronic messaging techniques (electronic mail, electronic chatting, text messaging, etc.) may associate a user profile with every user with whom a sending user communicates. The electronic messaging techniques can then utilize a specific user profile to identify and transmit a message from the sending user to a specific user associated with the specific user profile. Some users may have or be referred to by a plurality of different names. For example, a user may have a given or legal name (“Michael”), but the user may also utilize an alternate name (“Mike”). Additionally, for example, the user may have a given or a legal name (“Michael”), but the user may also be referred to as an alternative name (“Dad”) by others.

Accordingly, techniques are presented for automatically determining and using alternate names for users at computing devices. These techniques can provide for an improved user experience because automatically determining and using alternate names for users can be faster than the manual input of alternate names and these alternate names can also be used to generate more intelligent suggestions for the sending user. It should be appreciated that the term “alternate name” as used herein can refer to any name that is different than a user's legal or given name, e.g., a nickname, or any name that is different than a registered name associated with a computing profile, e.g., a name associated with owner of an e-mail account. It should also be appreciated that while the techniques of the present disclosure are described as being implemented at a server, these techniques can be implemented at any suitable computing device(s) including one or more processors.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

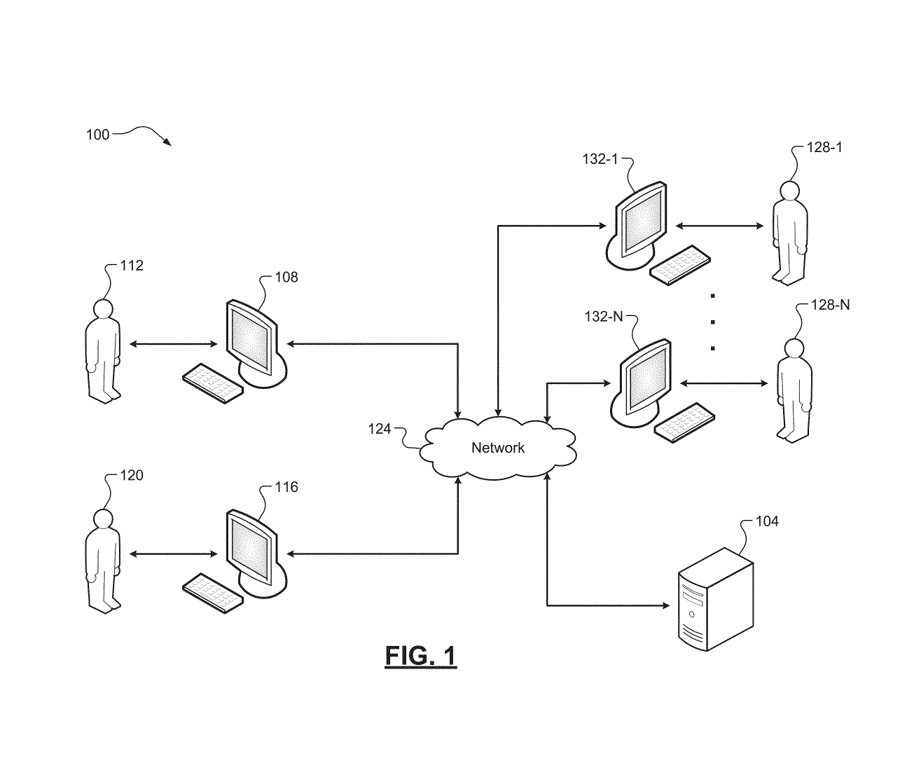

Referring now to FIG. 1, a computing system 100 is illustrated. The computing system 100 can include an example server 104 according to some implementations of the present disclosure. A “server” can refer to any suitable computing device that includes one or more processors and is configured to implement the techniques according to some implementations of the present disclosure. A server can also be a system that includes one or more devices, e.g., multiple devices configured to execute the techniques of the present disclosure. The computing system 100 can also include a first computing device 108 associated with a first user 112 and a second computing device 116 associated with a second user 120.

The second computing device 116 can be configured to communicate with the first computing device 108 via a network 124. For example, the network 124 can include a local area network (LAN), a wide area network (WAN), e.g., the Internet, or a combination thereof. The network 124 can also represent other suitable communication mediums (Bluetooth, WiFi Direct, near field communication (NFC), etc.). The second user 120 can generate an electronic message (electronic mail, an electronic chat message, a text message, etc.) at the second computing device 116. The second user 120 can then initiate a transmission of the electronic message to the first user 112 at the receiving computing device 108 via the network 124. It should be appreciated that the second computing device 116 can also receive electronic messages and, similarly, the first computing device 108 can also transmit electronic messages. The first and second computing devices 108, 116 can also be configured to communicate with the server 104.

The computing system 100 can also include a plurality of training users 128-1 . . . 128-N (N>1, collectively referred to as “training users 128”) associated with a plurality of training computing devices 132-1 . . . 132-N (collectively referred to as “training computing devices 132”), respectively. The training users 128 can represent any users that transmit electronic messages via the network 124 using their respective training computing devices 132. For example, these electronic messages may be configured to be routed through the server 104. These electronic messages can also be referred to as training data. More specifically, the server 104 can utilize these electronic messages as part of the techniques according to some implementations of the present disclosure, which are described in detail below. It should be appreciated that while the techniques according to some implementations of the present disclosure are described with respect to the server 104, the techniques according to some implementations of the present disclosure could also be similarly implemented at the sending computing device 108, the receiving computing device 116, or any other suitable computing device.

The server 104 can identify name context in the electronic messages (the training data) to determine patterns that each include specific name context and an identifier for a name. The server 104 can then select and store a set of the patterns that, when applied to the electronic messages, extract candidate names having greater than a predetermined matching accuracy with actual names in the electronic messages. The server 104 can additionally or alternatively apply patterns to electronic messages associated with the first user 112 to select and store a set of alternate names of the first user 112 having greater than a predetermined usage rate in the electronic messages. The server 104 can then detect a use of one of the alternate names of the first user 112 by the second user 120, and output a suggestion identifying the first user 108 to the second user 120. These techniques are now described in more detail below.

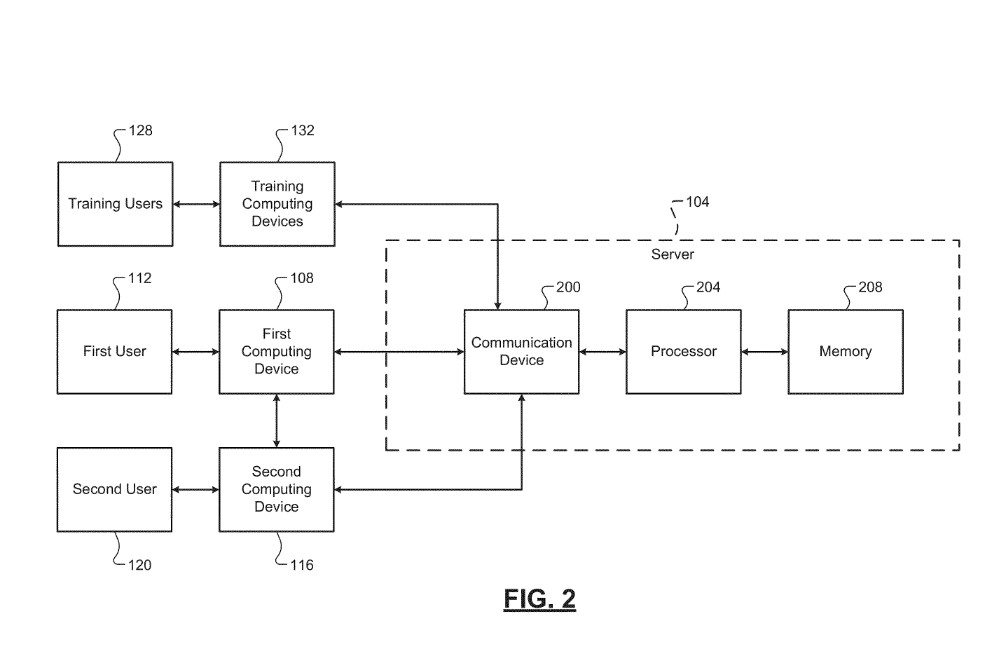

Referring now to FIG. 2, a functional block diagram of the example server 104 is illustrated. The server 104 can include a communication device 200, a processor 204, and a memory 208. It should be appreciated that the server 104 can also include other suitable computing components, and the term “processor” as used herein can refer to both a single processor and two or more processors operating in a parallel or distributed architecture.

The processor 204 can control operation of the server 104. Specifically, the processor 204 can perform functions including, but not limited to loading/executing an operating system of the server 104, controlling communication with other components on the network 124 via the communication device 200, and controlling read/write operations at the memory 208. The communication device 200 can include any suitable components configured for communication via the network 124, e.g., a transceiver. The memory 208 can be any suitable storage medium (flash, hard disk, etc.) configured to store information at the server 104. The processor 204 can also be configured to wholly or partially execute the techniques according to some implementations of the present disclosure, which are more fully described below.

The processor 204 can obtain a training corpus of electronic messages and use it to identify patterns. Examples of electronic messages include electronic mail, electronic chatting, text messaging, blogs, social media posts, and other electronic documents that reference one or more users. The processor 204 could also obtain an electronic document from other suitable electronic data associated with one or more users, e.g., speech-to-text to obtain text of voicemails. The processor 204 can obtain these electronic messages from the memory 208 and/or from one or more other computing devices via the communication device 200. These electronic messages can be used to determine patterns of name context, and the patterns can then be used in determining alternate names for users. These electronic messages, therefore, can also be referred to as “training electronic messages” or “training data.” For example, the training electronic messages can be associated with the users 128 and can be obtained at the processor 204 from the training computers 132 via the network 124 using the communication device 200.

After obtaining the training electronic messages, the processor 204 can identify name context in the training electronic messages in the training corpus. It should be appreciated that the term “name context” as used herein can refer to any text that is often presented in the context of names. For example only, the name context can refer to common greetings that are followed by a name (hello, hi, greetings, dear, etc.). Specifically, the processor 204 can identify N tokens surrounding each known name in each of the training electronic messages (N>0), where a “token” refers to a word or a punctuation. For example, a comma may follow a name in an introductory portion of a message, e.g., “Hello Mike,” and a question mark may follow a name in an introductory question in a message, e.g., “How are you Mike?” The processor 204 can identify known names by identifying particular fields in the training electronic messages in which names are typically used, e.g., TO and FROM fields in electronic mail. It should be appreciated that the processor 204 could also identify known names by leveraging other suitable resources, such as a global name database.

For example, one of the training electronic messages may be an electronic mail sent addressed to Mary Lee. This electronic mail can begin with the text “Good morning Mary, how are you?” The processor 204 could identify Mary as a known name by matching it with the TO field of the electronic mail. The processor 204 could then identify N tokens surrounding the name Mary. As previously mentioned, however, the processor 204 can remove the actual name after confirming that it is a known name. In this case, a placeholder or identifier could be inserted in place of the known name. In general, however, the processor 204 can identify an associated position for a name relative to the name context, e.g., after the term “Hello.” In this example of the electronic mail to Mary Lee, the processor 204 could identify patterns of up to N=4 tokens. The resulting patterns identified by the processor 204 could include:
Good morning NAMEPART
Good morning NAMEPART,
Good morning NAMEPART, how
morning NAMEPART,
morning NAMEPART, how
NAMEPART, (e.g., at a beginning of a message)
NAMEPART, how
   where NAMEPART represents the placeholder or identifier for the known name Mary. Note that the known name Mary is associated with the TO address of the electronic mail, and thus a more specific placeholder or identifier (TO_NAMEPART) associated with the TO address could be used.

After determining the patterns of name context from the training electronic messages, the processor 204 can apply the patterns to the training electronic messages to extract names from the training electronic messages. The candidate names can be extracted by matching the name context of a specific pattern to a specific training electronic message and then extracting a name using the associated position of the specific pattern. The processor 204 can then select a set of the patterns based on the extracted names to obtain a set of patterns. More specifically, the processor 204 can select the set of patterns based on statistics of the extracted names, which indicate accuracies of the patterns, respectively. For example only, the pattern “Good morning NAMEPART” may be identified in 5000 electronic mails, and the extracted name (NAMEPART) may match the TO field of the corresponding electronic mail in 4000 of the electronic mails. The resulting accuracy would be 4000/5000, or 80%.

The processor 204 can then select the set of patterns by selecting each pattern that, when applied to the training electronic messages, reliably extracts candidate names. Useful patterns can be selected using any of a variety of criteria, e.g., as having greater than a first predetermined matching accuracy with actual names in the training electronic messages. In other words, the processor 204 can calculate the accuracy of each of the patterns based on the gathered statistics, and can then select each of the patterns having greater than the first predetermined matching accuracy to obtain the set of patterns. The first predetermined matching accuracy can be indicative of a high degree of reliability that a specific pattern can be used to extract actual names from electronic messages. For example only, the first predetermined matching accuracy may be 80%, however, other suitable values for the first predetermined matching accuracy could be used, e.g., 50%. The set of patterns 204 can be stored at the memory 208 for later use. It should be appreciated that the set of patterns could also be revised in response to analysis of new training data.

In some implementations, the processor 204 can also determine a set of bad names. The term “bad names” as used herein refers to alternate names for users, e.g., nicknames, that are not user-specific. The set of bad names can also be referred to as a set of ambiguous names. Examples of bad names can include, but are not limited to “guys,” “all,” “you,” and the like. The processor 204 can determine the set of bad names in a variety of different ways. In one implementation, the processor 204 can apply the set of patterns to the training electronic messages to extract candidate names. The processor 204 can then select the bad names from the candidate names that are not useful for matching. For example, bad names can be selected by determining which of the candidate names have less than a second predetermined matching accuracy to the actual names. The second predetermined matching accuracy can be indicative of a high degree of reliability that a specific name is not user-specific. The second predetermined matching accuracy, therefore, can be less than or equal to the first predetermined matching accuracy. For example only, the second predetermined matching accuracy could be 10%, however, other values for the second predetermined matching accuracy could be used, e.g., 50%. The set of bad names can then be stored at the memory 208. In some cases, the set of bad names could also be revised in response to analysis of new training data.

After selecting the set of patterns, the set of patterns can then be applied to determine alternate names for users at computing devices. The patterns can be applied to any corpus of electronic messages, typically electronic messages that were not in the training corpus. For example, the processor 204 can obtain electronic messages associated with a user with the user's consent or on the user's request. The electronic messages are associated with a registered profile of the first user 112. The registered profile can be any suitable computer profile or account having at least one registered name for the first user 112 (an electronic mail address/account, an electronic chatting username, a text messaging name/phone number, a blog or social media account, etc.). The processor 204 can obtain the electronic messages from the memory 208, e.g., server-side electronic message storage, and/or from one or more other computing devices, e.g., the first computing device 108, via the communication device 200. At least some of the electronic messages could also be obtained from other computing devices via the communication device 200. For example, the processor 204 could obtain at least some of the electronic messages from the second computing device 116 when the second user 120 is also associated with electronic messages that are associated with the registered profile of the first user 112, with the appropriate consent of the respective users. In addition, any transmission of the electronic messages can include appropriate encryption to protect sensitive user information.

The processor 204 can then apply the set of patterns to the electronic messages to extract candidate names for the first user 112. These candidate names represent potential alternate names for the first user 112. Rather, these candidate names are potential alternatives to the at least one registered name of the registered profile of the first user 112. After extracting the candidate names for the first user 112, the processor 204 can then select a set of the candidate names having greater than a predetermined usage rate in the electronic messages to obtain a set of alternate names for the first user 112. The predetermined usage rate can be indicative of a high degree of reliability that a specific name is an alternate name for the first user 112. The predetermined usage rate could be a predetermined number of usages/occurrences in the electronic messages, a predetermined usage percentage, or another suitable metric. For example only, the predetermined usage rate could be 100 usages/occurrences in the electronic messages. The processor 204 can then store the set of alternate names for the first user 112 at the memory 208. It should be appreciated, however, that the set of alternate names could be revised in response to new/future electronic messages associated with the registered profile of the first user 112.

Once the processor 204 has determined the set of alternate names for the first user 112, the processor 204 can provide suggestions to help assist other users. More specifically, the processor 204 can detect a use of one alternate name from the set of alternate names by another user at a computing device. For the purposes of this disclosure, the other user will be the second user 120 and the computing device will be the second computing device 116. The processor 204 could detect the use of the one alternate name using any suitable techniques, such as direct interaction with the second computing device 116 via the network 124 or by being notified by another computing device of the use by the second user 120 at the second computing device 116. In response to detecting that the second user 120 has used one alternate name from the set of alternate names for the first user 112, the processor 204 can perform one or more actions.

Specifically, the processor 204 can output a suggestion to the second user 120 at the second computing device 116 via the network 124 using the communication device 200. The term “suggestion” as used herein can be any type of information indicative of the registered profile or the at least one registered name of the first user 112 in the registered profile. Examples of detectable uses by the second user 120 can include, but are not limited to text in an address field of an electronic mail, text in a search query field, or text at a social network website. In some implementations, the suggestion can cause the second computing device 116 to automatically select one name from the set of alternate names for the first user 112. For example, the suggestion may cause the second computing device 116 to automatically select a registered name for the first user 112 that is associated with his/her registered profile. It other implementations, however, the suggestion could cause the second computing device 116 to present at least one of the alternate names for the first user 112 to the second user 120. For example only, this presentation could be a pop-up window or a list of alternate names, which could be ordered based on relative likelihood.

Specific example suggestions for the various example uses above will now be described. In a first example, when the use of the one alternate name by the second user 120 is in a search query, the suggestion can be a result for the search query that is further based on the registered profile for the first user 112. For example only, the search query could be “When does Mike's flight arrive?” and the result could retrieve flight information associated with the registered profile for Michael, who is associated with the second user 120 and also goes by Mike. In a second example, when the use of the one alternate name by the second user 120 is in an address field of a draft electronic message or a body of the draft electronic message, the suggestion can be an address for the first user 112 from the registered profile, e.g., “Mike@______.” In a third and final example, when the user of the alternate name by the second user 120 is at a social network website, the suggestion can be a suggestion for the second user 120 to add the first user 112 to a group of users associated with the second user 120 at the social network website.

It should be appreciated that other suitable uses and/or suggestions can be implemented. When a name is shared by multiple users, a specific user can be identified based on context of the electronic messages. For example, when a user is associated with three other users that can be referred to as “Mike” and user has input the search query asking “When does Mike's flight arrive?”, the techniques can identify which of the three other users is associated with a recent or upcoming flight to determine the specific other user being referred to by the user.

As previously discussed, the processor 204 may have determined a set of bad names. The set of bad names is likely user-generic, but in some cases could be user-specific. The processor 204 can utilize the set of bad names to enhance the outputting of suggestions to users. Specifically, the processor 204 can utilize the set of bad names when selecting the set of alternate names for the first user 112 by not selecting any names from the set of bad names and/or, when outputting the suggestion to the second user 120, by not suggesting any names from the set of bad names.

It should also be appreciated that the set of alternate names for the first user 112 can be utilized for other purposes. In some implementations, the set of alternate names for the first user 112 can be specific to each other user, e.g., specific to the second user 120. In such cases, other information about the first user 112 and/or the second user 120 can be determined from the set of alternate names or during the process of selecting the alternate names. This information could include familial relationships between users. For example, when “Mom” is a selected alternate name for the first user 112 from electronic messages associated with the second user 120, the processor 204 can determine a mother-child relationship between the first user 112 and the second user 120, respectively. This information could then be further utilized, such as by suggesting to the second user 120 to add the first user 112 to a family-specific group at a social media website.

Further, sets of alternate names can be aggregated across multiple users to obtain a global alternate name database. This global alternate name database can include alternate names for each of a plurality of names. For example, the alternate name “Mike” for the name “Michael” can be utilized for other users named Michael. In other words, the techniques of the present disclosure could assume that all other users named Michael can also be called Mike. This could include more easily obtaining sets of alternate names for each of these other users named Michael and/or outputting suggestions based on registered profiles associated with these other users named Michael. For example, the server 104 could output a suggestion to a search query relating to “Mike Smith” that causes the second computing device 116 to obtain search results relating to “Michael Smith.” This global alternate name database, as well as specific alternate name lists for specific users, can be shared across different domains, e.g., across different applications. For example, specific alternate names for a specific user may be determined via electronic messages in an electronic mail application, but these specific alternate names can then also be used in other applications, such as when voice-activated dialing, e.g., “dial Mike.” These lists of specific alternate names for specific users, therefore, can be user-specific, and therefore could be stored locally at a user's personal computing device, e.g., a mobile phone. For example, the alternate name “Dad” for the user Michael may only be used by Michael's children.

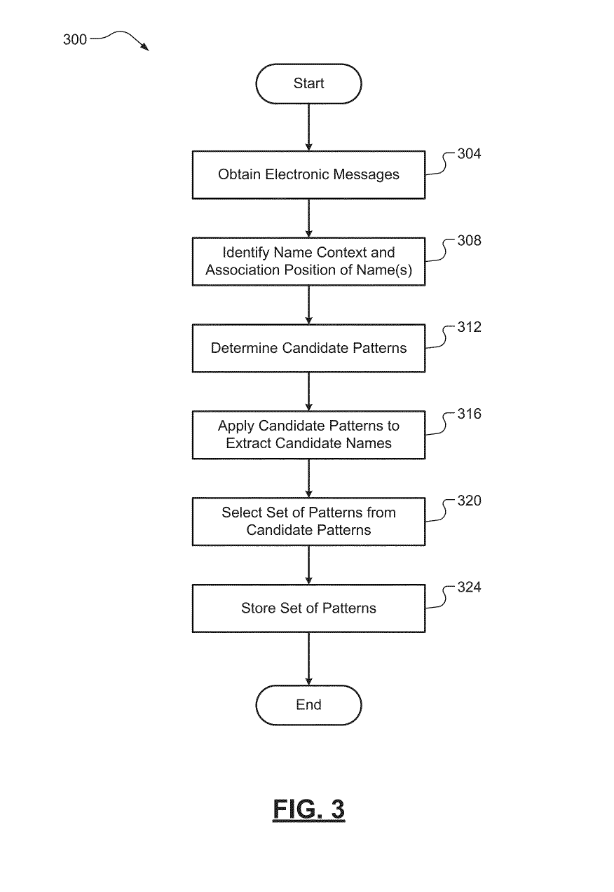

Referring now to FIG. 3, a flow diagram of an example technique 300 for automatically determining patterns of name context from electronic messages is illustrated. At 304, the server 104 can obtain training electronic messages, e.g., the training data. At 308, the server 104 can identify name context in the training electronic messages. At 312, the server 104 can determine patterns from the name context, each pattern including name context around a name and an associated position for the name relative to the name context. At 316, the server 104 can apply the patterns to the training electronic messages to extract candidate names that correspond to the associated positions to obtain extracted candidate names. At 320, the server 104 can select a set of the patterns based on the extracted candidate names to obtain a set of patterns. At 324, the server 104 can store the set of the patterns, e.g., at the memory 208. The technique 300 can then end or return to 304 for one or more additional cycles.

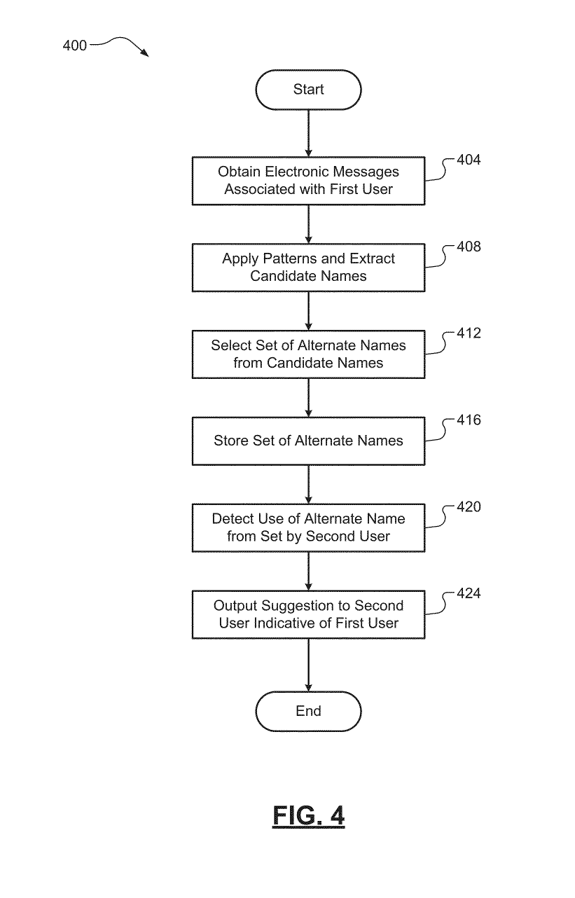

Referring now to FIG. 4, a flow diagram of an example technique 400 for automatically determining and using alternate names for users at computing devices is illustrated. At 404, the server 104 can obtain training electronic messages associated with the first user 112. The first user 112 also has a registered profile, e.g., an e-mail account. At 408, the server 104 can apply a set of patterns to the training electronic messages to extract candidate names for the first user 112, each pattern of the set of patterns including specific name context and an associated position for a name relative to the name context. At 412, the server 104 can select a set of the candidate names having greater than a predetermined usage rate in the training electronic messages to obtain a set of alternate names for the first user 112. At 416, the server 104 can store the set of alternate names for the first user 112, e.g., at the memory 208. At 420, the server 104 can detect a use of one alternate name from the set of alternate names by the second user 120. At 424, the server 104 can output a suggestion to the second user 120, the suggestion being based on the registered profile for the first user 112. The technique 400 can then end or return to 404 for one or more additional cycles.

Numerous specific details are set forth such as examples of specific components, devices, and methods, to illustrate different possible embodiments of the present disclosure. It will be apparent to those skilled in the art that not all specific details need be employed, that example embodiments may be embodied in many different forms and that neither should be construed to limit the scope of the disclosure. The method steps, processes, and operations described herein are not to be construed as necessarily requiring their performance in the particular order discussed or illustrated, unless specifically identified as an order of performance. It is also to be understood that additional or alternative steps may be employed.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, electrically-addressed non-volatile memory (NVM) (e.g., mask read-only memory (ROM), erasable programmable ROM (EPROM), electrically erasable programmable ROM (EEPROM), magnetoresistive random-access memory (RAM) (MRAM) and ferroelectric RAM (FRAM)), mechanically-addressed NVM (e.g., flash memory, hard disks, optical discs, such as CDs/DVDs, magnetic discs or tape, and holographic memory), volatile memory (e.g., random access memory (RAM), such as static RAM (SRAM) and dynamic RAM (DRAM), application specific integrated circuits (ASICs), organic or organic-based memory, or any other type of media suitable for storing information electronically. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
obtaining, at a server including one or more processors, training electronic messages;
identifying, at the server, one or more name contexts in the training electronic messages;
determining, at the server, patterns from the name contexts, each pattern including a context around a name and an associated position for the name relative to the context;
applying, at the server, the patterns to the training electronic messages to extract candidate names that correspond to the associated positions to obtain extracted candidate names;
selecting, at the server, a set of the patterns based on the extracted candidate names; and
storing, at the server, the set of patterns.

2. The computer-implemented method of claim 1, wherein the training electronic messages are obtained from plurality of training users, and wherein each specific training electronic message includes at least one known name associated with a specific field of the specific training electronic message.

3. The computer-implemented method of claim 2, wherein identifying the one or more name contexts in the training electronic messages includes identifying, at the server, N tokens surrounding each known name, wherein each token is a word or a punctuation, and wherein N is an integer greater than zero.

4. The computer-implemented method of claim 3, wherein determining the patterns includes determining, at the server, context for each combination of the N tokens surrounding the known name and determining the associated position at the known name to obtain the patterns.

5. The computer-implemented method of claim 1, wherein selecting the set of the patterns includes selecting each pattern that, when applied to the training electronic messages, extracts candidate names having greater than a first predetermined matching accuracy with actual names in the training electronic messages.

6. The computer-implemented method of claim 1, further comprising:
obtaining, at the server, electronic messages associated with a first user, the first user having a registered profile;
applying, at the server, the set of patterns to the electronic messages to extract candidate names for the first user;
selecting, at the server, a set of the candidate names having greater than a predetermined usage rate in the electronic messages to obtain a set of alternate names for the first user; and
storing, at the server, the set of alternate names for the first user.

7. The computer-implemented method of claim 6, further comprising:
detecting, at the server, a use of one alternate name from the set of alternate names by a second user at a computing device; and
outputting, from the server, a suggestion for the second user to the computing device, the suggestion being based on the registered profile for the first user.

8. The computer-implemented method of claim 7, wherein outputting the suggestion causes the computing device to automatically select a name for the first user that is associated with the registered profile for the first user.

9. The computer-implemented method of claim 7, wherein the use of the one alternate name by the second user is one of:
(i) in a search query, wherein the suggestion is a result for the search query that is further based on the registered profile for the first user,
(ii) in an address field of a draft electronic message or a body of the draft electronic message, wherein the suggestion is an address for the first user from the registered profile, and
(iii) at a social network website, wherein the suggestion is a suggestion for the second user to add the first user to a group of users associated with the second user at the social network website.

10. The computer-implemented method of claim 7, further comprising:
applying, at the server, the set of patterns to the training electronic messages to extract candidate names for the training users;
selecting, at the server, a set of the candidate names having less than than a second predetermined matching accuracy with actual names in the training electronic messages to obtain a set of ambiguous names, wherein the second predetermined matching accuracy is less than the first predetermined matching accuracy; and
utilizing, at the server, the set of ambiguous names when selecting the set of alternate names for the first user by not selecting any names from the set of ambiguous names and when outputting the suggestion to the second user by not suggesting any names from the set of ambiguous names.

11. A computer-implemented method, comprising:
obtaining, at a server including one or more processors, electronic messages associated with a first user, the first user having a registered profile;
applying, at the server, a set of patterns to the electronic messages to extract candidate names for the first user, each pattern of the set of patterns including specific name context and an associated position for a name relative to the specific name context;
selecting, at the server, a set of the candidate names to obtain a set of alternate names for the first user;
storing, at the server, the set of alternate names for the first user;
detecting, at the server, a use of one alternate name from the set of alternate names by a second user at a computing device; and
outputting, from the server, a suggestion for the second user to the computing device, the suggestion being based on the registered profile for the first user.

12. The computer-implemented method of claim 11, wherein selecting the set of alternate names for the first user includes selecting candidate names having greater than a predetermined usage rate in the electronic messages to obtain the set of alternate names for the first user.

13. The computer-implemented method of claim 11, wherein the use of the one alternate name by the second user is one of:
(i) in a search query, wherein the suggestion is a result for the search query that is further based on the registered profile for the first user,
(ii) in an address field of a draft electronic message or a body of the draft electronic message, wherein the suggestion is an address for the first user from the registered profile, and
(iii) at a social network website, wherein the suggestion is a suggestion for the second user to add the first user to a group of users associated with the second user at the social network website.

14. The computer-implemented method of claim 11, further comprising:
obtaining, at the server, training electronic messages;
identifying, at the server, one or more name contexts in the training electronic messages; and
determining, at the server, candidate patterns from the name contexts, each pattern including specific name context and an associated position for a name relative to the specific name context, each candidate pattern being a candidate for the set of patterns.

15. The computer-implemented method of claim 14, further comprising:
applying, at the server, the candidate patterns to the training electronic messages to extract candidate names that correspond to the associated positions;
selecting, at the server, each candidate pattern that, when applied to the training electronic messages, extracts candidate names having greater than a first predetermined matching accuracy with actual names in the training electronic messages to obtain the set of patterns; and
storing, at the server, the set of the patterns.

16. The computer-implemented method of claim 15, wherein the training electronic messages are obtained from plurality of training users, and wherein each specific training electronic message includes at least one known name associated with a specific field of the specific training electronic message.

17. The computer-implemented method of claim 16, wherein identifying the name context in the training electronic messages includes identifying, at the server, N tokens surrounding each known name, wherein each token is a word or a punctuation, and wherein N is an integer greater than zero.

18. The computer-implemented method of claim 17, wherein determining the patterns includes determining, at the server, name context for every combination of the N tokens surrounding the known name and determining the associated position at the known name to obtain the patterns.

19. The computer-implemented method of claim 15, wherein selecting the set of patterns includes selecting each candidate pattern that, when applied to the training electronic messages, extract candidate names having greater than a first predetermined matching accuracy with actual names in the training electronic messages;

20. The computer-implemented method of claim 19, further comprising:
applying, at the server, the set of patterns to the training electronic messages to extract candidate names for the training users;
selecting, at the server, a set of the candidate names having less than a second predetermined matching accuracy with actual names in the training electronic messages to obtain a set of ambiguous names, wherein the second predetermined matching accuracy is less than the first predetermined matching accuracy; and
utilizing, at the server, the set of ambiguous names when selecting the set of alternate names for the first user by not selecting any names from the set of ambiguous names and when outputting the suggestion to the second user by not suggesting any names from the set of ambiguous names.
